(19) United States
(12) Patent Application Publication
(10) Pub. No.: US 2015/0242120 A1
(43) Pub. Date: Aug. 27, 2015

(54) DATA INPUT PERIPHERALS AND METHODS

(71) Applicant: Digimarc Corporation, Beaverton, OR (US)

(72) Inventor: Tony F. Rodriguez, Portland, OR (US)

(21) Appl. No.: 14/629,159

(22) Filed: Feb. 23, 2015

Related U.S. Application Data
(60) Provisional application No. 61/943,137, filed on Feb. 21, 2014.

(51) Int. Cl. G06F 3/0488; G06F 1/16; G06F 3/044; G04G 21/08

(52) U.S. Cl. CPC G06F 3/04886; G04G 21/08; G06F 1/163; G06F 3/044; G06F 2203/04104

(57) ABSTRACT

A smart watch is equipped with a sensor array adapted to allow the watch (including the watchband) to serve as a text entry device, in lieu of a conventional QWERTY keyboard. A variety of other features and arrangements are also detailed.

### RELATED APPLICATION DATA

The present application claims priority to copending provisional application 61/943,137, filed Feb. 21, 2014.

### INTRODUCTION

Smart phones now have capabilities rivaling those of laptop and desktop computers. Multi-core processors are commonly used, with abundant memory. Smartphones are superior in some respects, including better connectivity, and a richer collection of sensors. And, of course, they are more mobile.

The principal impediment to abandoning desktop computers altogether is the limited keyboard input capabilities of smart phones. (For many applications, the small screen limitation of a smart phone is not a big concern. And where a larger screen is needed, the growing ubiquity of screens offers the possibility of simply slinging the display data to a nearby public or private screen. Also, smartphones are beginning to include projection capabilities—allowing for large projected displays.)

This problem of a keyboard is most commonly addressed, presently, by use of an accessory keyboard, coupled to the smart phone by Bluetooth or the like. However, such keyboards are cumbersome, and represent yet another piece of electronic baggage to carry.

Smart watches are growing in popularity. Apart from some sports and biometric sensing applications, their present utility is largely for communicating notifications to users, e.g., visually or audibly announcing imminent calendar appointments and the arrival of certain messages.

In accordance with one aspect of the present technology, a smart watch is equipped with a sensor array adapted to allow the watch (including the watchband) to serve as a text entry device, in lieu of an accessory keyboard.

The foregoing and other features and advantages of the present technology will be more readily apparent from the following detailed description, which proceeds with reference to the accompanying drawings.

### BRIEF DESCRIPTION OF THE DRAWINGS

FIG. 1 illustrates one arrangement employing certain principles of the present technology.

FIG. 2 illustrates another arrangement employing certain principles of the present technology.

FIG. 3 illustrates a prior art QWERTY keyboard.

FIG. 4 is a side view of the device of FIG. 2

### DETAILED DESCRIPTION

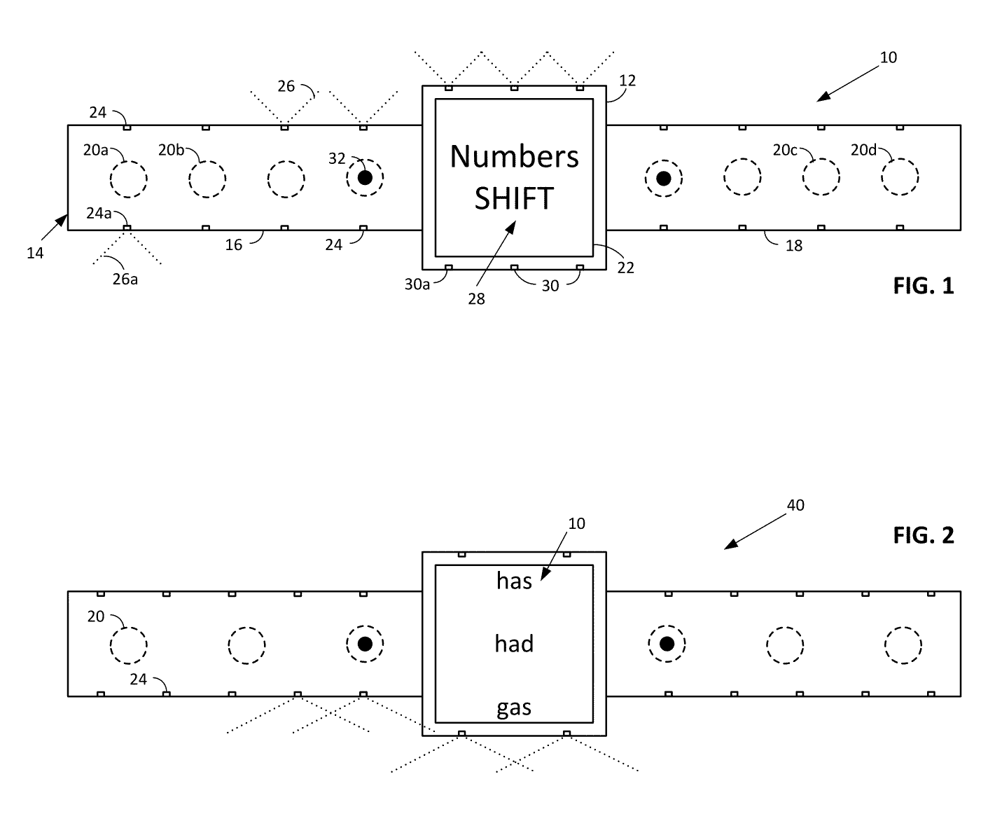

Referring to FIG. 1, one embodiment 10 employing aspects of the present technology comprises a wristwatch including a central unit 12 and a wristband 14. The wristband includes a first portion 16 extending from the central unit in a first direction, and a second portion 18 extending from the central unit in an opposite direction. (The wristband also typically includes coupling features (e.g., a buckle) at the ends of these portions, but these are not shown in FIG. 1 for clarity of illustration.)

Each of these wristband portions includes a sensor array. The array is adapted to sense and distinguish taps by index, middle, fourth and pinky fingers on a top surface of such wristband portion.

Each of these sensor arrays can include plural component sensors 20. Four are shown in FIG. 1, which works out to one for each index-pinky finger for the left and right hand. This can simplify detection, since the sensor with the strongest output signal indicates which of these four fingers was used. However, a greater or lesser number can be used, and signals from the sensors can be analyzed to discern information about the most probable finger tap that led to the resulting ensemble of sensor output signals. A corresponding QWERTY keyboard key is thereby estimated.

(As is familiar, the sensors referenced herein can be of various sorts. One is a LED/photodetector pair, which illuminates a nearby area, and senses light reflected from a finger that is introduced into that illuminated area. Another is an accelerometer (which may be a 3D MEMS accelerometer)—sensing the magnitude (and optionally direction) of movement/vibration at the sensor location. Another is an acoustic sensor, such as a MEMS microphone. Still another is a capacitive or inductive sensor—an electrical circuit in which presence of a proximate human finger causes the circuit behavior to change. Other sensors—including some not yet known—can naturally be employed as well.)

The eight sensors 20 in the FIG. 1 watchband 14 serve to sense finger actions corresponding to keys in the “home row” of a conventional QWERTY keyboard (shown in FIG. 3). That is, the fingers of the left hand correspond to the letters A, S, D and F. Similarly, the fingers of the right hand correspond to the symbols J, K, L and semicolon.

The letters G and H of the home row are sensed—in the illustrated arrangement—by index finger touches to a touch-screen surface 22 of the central unit 12. That is, a touch to the center-left side of the touch screen is regarded as a G, and a touch to the center-right side is regarded as an H.

There are a few other keys on the home row of a QWERTY keyboard. To the left of the A is the CapsLock key, and to the right of the semicolon key is the single-quote key. These are tapped with the user's left and right pinkies, respectively—by extending a bit away from the rest of the hand. Such taps can be sensed by signals from the outer sensors 20a, 20d that aren't quite sensed as direct taps, but are consistent with an off-sensor, displaced tap. (The signal sensed by sensor 20a can be compared with the signal sensed by sensor 20b to confirm that the user tapped to the left of the sensor 20a—not to its right, thus intending the CapsLock key, etc.)

The other key on the home row is the Enter key, to the right of the single-quote key. The same sensor signal that indicates the user intended to select the single-quote key can also serve to indicate that the user intended to select the Enter key, with the two distinguished by context. (E.g., the Enter key is commonly used at the end of a sentence, after a period, and before a Tab character or a capital letter. The single-quote key, in contrast, is most commonly used as an apostrophe, immediately preceded and followed by a letter—most commonly ‘t’ or ‘s’.)

As suggested by the foregoing, the signals output by the sensors will be noisy, in the sense that they will only rarely, per se, unambiguously indicate a single desired QWERTY keystroke. Accordingly, typing will rely heavily on auto-correction, word-guessing and predictive spelling/text techniques, which are already well developed in existing word processing and smartphone applications. Especially since there often will be no visual clues (e.g., symbol legends) for the user to aim at as targets, typing will be a probabilistic affair. Thus, probabilistic techniques should be employed to polish the user's raw data entry.

(While sensors 20 have been illustrated as being positioned along a center axis of the watchband, this is not essential. For example, they may be positioned on one side, or both sides, of the axis. Such positioning is regarded as being in a median portion of the band, as contrasted with along its edge.)

So far, only a single row of symbols has been discussed (CapsLock—Enter). The device needs also to support the other rows of keys on a conventional QWERTY keyboard.

These other rows are enabled, in part, by sensors 24 of the sensor array that are disposed in the two edge regions of each portion of the watchband.

Again, four such sensors 24 are shown in each edge region of the illustrated first and second watchband portions. These sensors 24 produce an output signal when a fingertip is brought into proximity. The closer the fingertip approaches the sensor, the stronger the output signal. The dotted lines 26 in FIG. 1 indicate a region in which presence of a fingertip results in the strongest sensor output signal.

To type the letter Z, the user employs the pinky of the left hand, moving it downwards (towards their body), into the region 26a in front of the sensor 24a. (The user may touch whatever surface the wristwatch is resting on, but this is not essential.) Similarly for the other keys X, C, V and M, comma, period, and forward-slash found on the row below the home row of a conventional QWERTY keyboard.

The letters B and N, in the middle of this row, can be sensed by taps to the lower left and right corners of the touch screen 22. Alternatively, the central unit 12 can be provided with edge sensors 30 akin to sensors 24. In this case, the user can type a B by extending the left index finger below left side of the central unit 12, where it will be sensed by sensor 30a. Similarly for the letter N.

The Shift keys found at the left end of this lower row can be sensed in the manner described above for the CapsLock key, i.e., employing a signal from the outermost-sensor 24a on the watchband, which doesn't seem to be a “direct” hit in the target region 26a. Also, again, context can be used to resolve ambiguity (e.g., the situations in which a Shift key was intended are generally readily distinguishable from the situations in which the Z key was intended).

In similar fashion, the keys Tab, Q, W, E, R, T, Y, U, I, O, P, comma and back-slash, from the row above the home row, can be sensed using sensors 24 along the top edge (as pictured) of the watch band portions.

Above this just-discussed QWERTY row of keys is a row comprising number and symbol keys. In the illustrated embodiment, the user—by input such as a gesture on the touchscreen 22 (e.g., a double-tap, while in the described text entry mode), or a combination of taps on the sensors 20, 24—invokes a Numerals mode. When the watch enters this mode, a corresponding indicia is presented on the screen. For example as shown at 28 in FIG. 1, the legend “Numbers SHIFT” can be presented. Alternatively, a color clue (e.g., blue) can be presented on the screen to signal that data entry is in the Numerals mode. The color clue can flood the entire touch screen display, or it can simply color the background of information otherwise presented on the screen. The watch can be manually toggled out of this mode, e.g., using the same gesture/taps that initiated it, or the watch can automatically switch out of this mode based on context (in a manner like the Numbers mode of text entry using the familiar on-screen iPhone keyboard).

In like fashion, another gesture or combination of taps can invoke a Function Key mode. When this mode is invoked, keys including F1-F12 can be selected by taps on the home row. Again, a corresponding indicia is presented on the touch screen 22.

The Space bar may be keyed by tapping—with the left and right thumbs, essentially simultaneously (i.e., within 30 or 100 milliseconds of each other)—along the bottom margin of the touch screen 22. Alternatively, a tap below and remote from the central unit, e.g., in a region 42, can signal entry of a space.

FIG. 2 shows a variant arrangement 40. In this embodiment, each watchband portion includes three sensors 20. And each watchband edge includes five sensors 24. Given the sparser placement of sensors 20 along the band, signals from the edge sensors 24 can be used to help discern placement of a finger tap on the body of the band.

The edge region sensors 24 are also indicated (by dotted lines) to have a larger “field of sensing” than those in FIG. 1. Thus, a finger tip placed near one of these edges will typically produce output signals from several such sensors. Their relative strengths help localize the precise placement of the finger tip.

FIG. 2 shows that the number of sensors 20 in the median portion of the watchband can be different than the number of sensors 24 along each edge. (While not particularly shown, the number of sensors 24 along one edge may be different than the number of sensors 24 along the other edge.)

The touchscreen of the FIG. 2 arrangement shows that auto-correction can employ the touchscreen of the watch—presenting strings that were possibly intended by the user. The user indicates the desired string by a tap on the word as displayed on the screen.

Normally it is expected that the user's smartphone is positioned with the display screen (e.g., of a smartphone) face-up and oriented for easy user viewing while typing. For example, it may be positioned, centered, above the FIG. 1 watch. The user may track the typing progress on this screen. Alternatively, or additionally, the text entered by the user may be presented on the touch screen 22 of the smart watch, either symbol by symbol, or a word at a time.

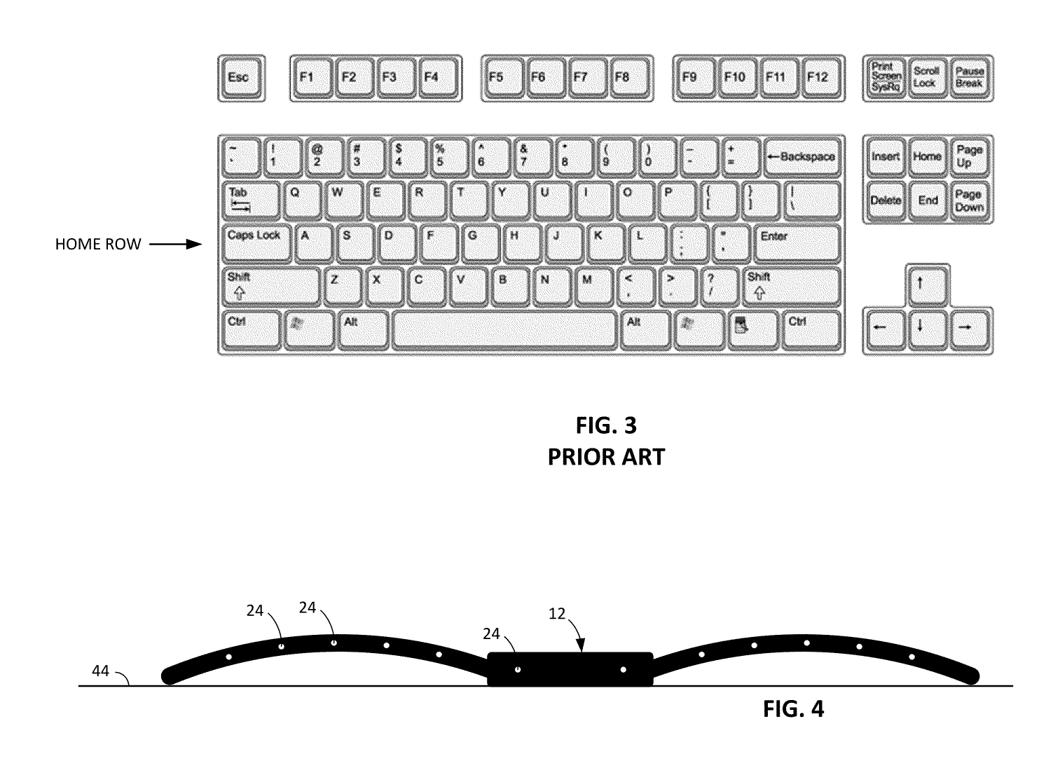

The depicted arrangement can naturally be used on a desk. A side view of such a watch, resting on a desk or other planar surface 44, is shown in FIG. 4. This illustration shows the plural sensors 24 (e.g., photodiode/photosensor pairs) looking out from the side edge of the watch band and central unit. The bands may be arched—by design or through shaping by wear. Such arch can provide tactile “give” to finger taps on the band, which can aid in electronic sensing of the taps and in ergonomic feel.

The detailed arrangement is also well suited for lap work, e.g., when commuting on a bus. The watchband can be laid across the user's lower thigh, providing a comfortable placement for interaction.

Visual markings indicating the sensors' placement along the watchband may be provided to help orient the user. Or the band may have no visual indication as to sensor placement. Desirably, however, there are tactile clues to indicate a rest position of the user's index fingers. In the FIG. 1 watch, the clues are small raised dimples 32. In other embodiments, a depression (or hole) in each half of the wristband can serve this purpose.

There are many examples of smart watches that can be adapted with features as described herein. They include the Pebble Smartwatch, the Martian Smartwatch, the Sony Smartwatch 2 SW2, the Samsung Galaxy Gear smartwatch, and the Qualcomm Toq smartwatch. The Apple Watch device is perhaps best known of all. (Abundant information about these and other smart watch devices is available on the internet, including patent filings.) Some of these devices are available in different sizes, to accommodate differently-sized wrists. Generally, hand size correlates with wrist size. Thus, a watch for a larger wrist, with a longer wristband, would have a larger area over which to distribute the sensor array—thus accommodating use by larger hands.

While the foregoing description has focused on keyboard-like symbol entry, there is also the matter of a mouse-like functionality. A variety of sensors can be employed to receive user input signals indicating desired movement of a cursor on a separate display. One is a camera portion of the smart watch that views a space near the watch in which the user gestures. Another is the touchscreen itself. The user can gesture on the screen to signal desired movements of the cursor.

In the future, a smart watch's processing capabilities may rival that of smartphones, in which case the companion smartphone part of the system can be omitted.

It is expected that wearable computing devices can be used in conjunction with the present technology. An example is a faceworn display, such as the Google Glass device. In such arrangement, the text entered using the FIG. 1 device can be presented for review on the display of the headworn device.

Although the detailed arrangement provides no visual clues to indicate what symbols are “typed” by what finger movement (except the feature 32), in other embodiments various clues can be presented. This can include markings on the band. Additionally, or alternatively, the watch can be positioned on a “cheat sheet”—a page (or other substrate) with keyboard map markings to aid in finger placement. Or such a keyboard map can be provided otherwise, such as by an optical projector or display.

While the above description referred to finger “taps,” this is meant to be a broad term that does not necessarily denote movement. For example, a tap may be a touch or press to an area of the band, or the mere presence of a fingertip momentarily placed near a sensor.

It should be noted that the watch device, and/or the companion device, can be equipped with speech recognition capabilities, which can be used in conjunction with the present technology (e.g., to aid in correcting typing errors).

The artisan is presumed to be familiar with the previous work involving smart watches that is disclosed in US patent documents U.S. Pat. No. 6,144,366, 7,023,426, 8,624,836, 8,641,306, 20060177227, 20060195020, 20070191002, 20110059769, 20140045463, 20140045480 and 20140045547.

Naturally, it is expected that the device 10 is configured to perform other functions associated with known smart watches, not the least of which is displaying the current time of day.

Likewise, the artisan is presumed to be familiar with auto-correction, word-guessing and predictive spelling/text techniques. Technology in these fields includes that marketed by Nuance Communications (T9), Motorola (iTap), Eatoni Ergonomics (LetterWise, WordWise, and EQ3), Prevalent Devices (Phraze-It), Xrgomics (TenGO), Adaptxt, Clevertexting, Oizea Type, Intelabs (Tauto), WordLogic (Intelligent Input Platform). Some Apple products are understood to use the auto-correction technology detailed in published patent applications 20130050089, 20120167009, 20120166942 and 20090295737.

While the foregoing description discussed features of illustrative embodiments, they are exemplary only. Some key strokes have not been detailed, e.g., for the Escape key in the upper left corner of the QWERTY layout, as well as the cursor control keys. (One approach is to present keys that are not located close to the home row, as large graphical icons on a touch screen of a companion (e.g., smartphone) device. In the infrequent instances when these keys are needed, the user can reach and tap the corresponding icon on that screen. Thus, composing a document can involve alternately touching the watch, a surface on which the watch is resting, and a touch screen of the companion device.) These and other details of a commercial offering will be strongly influenced by usability testing, which will doubtless result in modification of many of the exemplary arrangements detailed herein.

From the foregoing, it will be recognized that a user can employ QWERTY touch typing skills, in conjunction with a wristwatch, to effect rapid, reliable, data entry—without the burden of carrying a separate peripheral.

### Concluding Remarks

While the technology has been particularly described in connection with entry of typed text, it is not so limited. For example, a watchband equipped with multiple accelerometers, magnetometers or gyroscopes (“motion sensors”) can serve as a highly discriminating gesture input device. Given the redundancy afforded by multiple sensors, error- and noise-terms present in the output data from one sensor can be identified, and mitigated, by reference to output data from one or more other sensors on the same wristband. Further, while a single sensor can describe the motion of a single point, an array of sensors encircling a user's wrist provides richer information about the arm's motion. For example, three motion sensors spaced-apart along the wrist band define a 2D plane. A line normal to this plane is oriented in the direction that the wrist-portion of the user's arm is pointing.

Moreover, sensors in the wristband can be used in connection with detection of biometric signals. For example, one or more motion sensors or microphones in the wristband can detect the wearer's pulse.

Similarly, signals from plural microphones in a wristband can be combined to form a beam-forming array.

In text-input applications, the watchband—or the central unit—can be equipped with one or more haptic actuators (see, e.g., patent publication 20120028577). Such actuator(s) can be used to provide feedback to the user. For example, if the system detects entry of a series of characters that makes no sense and that it cannot auto-correct, the haptic actuator may be used to issue and error signal. This signal will be coupled into whatever surface the device is on (e.g., table or thigh), and serve to alert the user to examine the thus-entered text for a possible mistake. Alternatively, haptic signals can be issued to confirm successful—rather than erroneous—text input.

The present technology is also suited for use with so-called Skinput systems. As summarized by a web page at Microsoft Research, Skinput is a technology that appropriates the human body for acoustic transmission, allowing the skin to be used as an input surface. In particular, Skinput resovlves the location of finger taps on the arm and hand by analyzing mechanical vibrations that propagate through the body. These signals are collected using an array of sensors worn as an armband. This approach provides an always available, naturally portable, and on-body finger input system. Wikipedia further explains that Skinput is a way to decouple input from electronic devices with the aim of allowing devices to become smaller without simultaneously shrinking the surface area on which input can be performed. While other systems, like SixthSense have attempted this with computer vision, Skinput employs acoustics, which take advantage of the human body's natural sound conductive properties (e.g., bone conduction). This allows the body to be annexed as an input surface without the need for the skin to be invasively instrumented with sensors, tracking markers, or other items. Skinput arrangements are detailed in various Microsoft patent publications, including 20090326406, 20100302137, 20110133934 and 20130181902.

Particularly contemplated smartphones include the Apple iPhone 6; smartphones following Google's Android specification (e.g., the Galaxy S4 phone, manufactured by Samsung, and the Google Moto X phone, made by Motorola), and Windows 8 mobile phones (e.g., the Nokia Lumia 1020).

Details of the Apple iPhone, including its touch interface, are provided in Apple's published patent application 20080174570.

The processing of signals from the sensor array, in some embodiments of the present technology, can take into account previously-observed user idiosyncrasies (e.g., concerning placement of finger taps). Related technology is detailed in Apple's patent publication 20130044063.

The design of smartphones, smart watches, and wearable devices referenced in this disclosure is familiar to the artisan. In general terms, each includes one or more processors, one or more memories (e.g. RAM), storage (e.g., a disk or flash memory), a user interface (which may include, e.g., a keypad, a TFT LCD or OLED display screen, touch or other gesture sensors, a camera or other optical sensor, a compass sensor, a 3D magnetometer, a 3-axis accelerometer, a 3-axis gyroscope, one or more microphones, etc., together with software instructions for providing a graphical user interface), interconnections between these elements (e.g., buses), and an interface for communicating with other devices (which may be wireless, such as GSM, 3G, 4G, CDMA, WiFi, WiMax, Zigbee or Bluetooth, and/or wired, such as through an Ethernet local area network, etc.).

The processes and system components detailed in this specification can be implemented as instructions for computing devices, including general purpose processor instructions for a variety of programmable processors, such as microprocessors (e.g., the Intel Atom, the ARM A5, the Qualcomm Snapdragon, and the nVidia Tegra 4), graphics processing units (GPUs, such as the nVidia Tegra APX 2600, and the Adreno 330—part of the Qualcomm Snapdragon processor), and digital signal processors (e.g., the Texas Instruments TMS320 and OMAP series devices), etc. These instructions can be implemented as software, firmware, etc. These instructions can also be implemented in various forms of processor circuitry, including programmable logic devices, field programmable gate arrays (e.g., the Xilinx Virtex series devices), field programmable object arrays, and application specific circuits—including digital, analog and mixed analog/digital circuitry. Execution of the instructions can be distributed among processors and/or made parallel across processors within a device or across a network of devices. Processing of data can also be distributed among different processor and memory devices. Cloud computing resources can be used as well. References to “processors,” “modules” or “components” should be understood to refer to functionality, rather than requiring a particular form of implementation.

Software instructions for implementing the detailed functionality can be authored by artisans without undue experimentation from the descriptions provided herein, e.g., written in C, C++, Visual Basic, Java, Python, Tcl, Perl, Scheme, Ruby, etc., in conjunction with associated data. Smartphones and other devices according to certain implementations of the present technology can include software modules for performing the different functions and acts.

Software and hardware configuration data/instructions are commonly stored as instructions in one or more data structures conveyed by tangible media, such as magnetic or optical discs, memory cards, ROM, etc., which may be accessed across a network. Some embodiments may be implemented as embedded systems—special purpose computer systems in which operating system software and application software are indistinguishable to the user (e.g., as is commonly the case in basic cell phones). The functionality detailed in this specification can be implemented in operating system software, application software and/or as embedded system software.

Another form of implementation is electronic circuitry that has been custom-designed and manufactured to perform some or all of the component acts, as an application specific integrated circuit (ASIC).

To realize such an implementation, the relevant functionality/module(s) (e.g., text auto-correction, etc.) are first implemented using a general purpose computer, using software such as Matlab (from Mathworks, Inc.). A tool such as HDLCoder (also available from MathWorks) is next employed to convert the MatLab model to VHDL (an IEEE standard, and doubtless the most common hardware design language). The VHDL output is then applied to a hardware synthesis program, such as Design Compiler by Synopsis, HDL Designer by Mentor Graphics, or Encounter RTL Compiler by Cadence Design Systems. The hardware synthesis program provides output data specifying a particular array of electronic logic gates that will realize the technology in hardware form, as a special-purpose machine dedicated to such purpose. This output data is then provided to a semiconductor fabrication contractor, which uses it to produce the customized silicon part. (Suitable contractors include TSMC, Global Foundries, and ON Semiconductors.)

Essentially all of the functions detailed above can be implemented in such fashion. However, because the resulting circuit is typically not changeable, such implementation is best used for component functions that are unlikely to be revised.

As indicated above, reference to a “module” that performs a certain function should be understood to encompass one or more items of software, and/or one or more hardware circuits—such as an ASIC as just-described.

Different of the functionality can be implemented on different devices. For example, in a system in which a smart watch communicates with a smart phone (or a cloud processor), different tasks can be performed exclusively by one device or the other, or execution can be distributed between the devices. The conversion of signals sensed by the sensors, e.g., into ASCII character data, is one example of a process that can be distributed in such fashion. Thus, it should be understood that description of an operation as being performed by a particular device (e.g., a smart watch) is not limiting but exemplary; performance of the operation by another device (e.g., a remote device), or shared between devices, is also expressly contemplated.

In like fashion, data can be stored anywhere: smart watch, smartphone, in the cloud, distributed, etc.

As indicated, the present technology can be used in connection with wearable computing systems, including headworn devices. Such devices typically include one or more sensors (e.g., microphone(s), camera(s), accelerometers(s), etc.), and display technology by which computer information can be viewed by the user—either overlaid on the scene in front of the user (sometimes termed augmented reality), or blocking that scene (sometimes termed virtual reality), or simply in the user's peripheral vision. A headworn device may further include sensors for detecting electrical or magnetic activity from or near the face and scalp, such as EEG and EMG, and myoelectric signals—sometimes termed Brain Computer Interfaces, or BCIs. (A simple example of a BCI is the Mindwave Mobile product by NeuroSky, Inc.) Exemplary wearable technology is detailed in patent documents U.S. Pat. No. 7,397,607, 20100045869, 20090322671, 20090244097 and 20050195128. Commercial offerings, in addition to the Google Glass product, include the Vuzix Smart Glasses M100, Wrap 1200AR, and Star 1200XL systems. An upcoming alternative is augmented reality contact lenses. Such technology is detailed, e.g., in patent document 20090189830 and in Parviz, Augmented Reality in a Contact Lens, IEEE Spectrum, September, 2009. Some or all such devices may communicate, e.g., wirelessly, with other computing devices (carried by the user or otherwise), or they can include self-contained processing capability. Likewise, they may incorporate other features known from existing smart phones and patent documents, including electronic compass, accelerometers, gyroscopes, camera(s), projector(s), GPS, etc.

Embodiments of the present technology can also employ neuromorphic processing techniques (sometimes termed “machine learning,” “deep learning,” or “neural network technology”). As is familiar to artisans, such processors employ large arrays of neuron-like elements—interconnected to mimic biological synapses. Such processors employ programming that is different than the traditional, von Neumann, model. In particular, connections between the circuit elements are weighted according to correlations in data that the processor has previously learned (or been taught). When a pattern of data (e.g., sensor data indicating finger taps) is applied to the processor (i.e., to inputs of several of the circuit elements), certain nodes may spike while others remain relatively idle. Each of these nodes may serve as an input to plural other circuit elements, triggering further spiking in certain other nodes—a chain reaction that ultimately provides signals to output nodes to indicate the results of the neuromorphic processing. (In addition to providing output signals responsive to the input data, this process can also serve to alter the weightings, training the network to better respond to certain patterns that it has seen (i.e., processed) before.) Such techniques are well suited for pattern recognition applications, among many others.

Additional information on such techniques is detailed in the Wikipedia articles on “Machine Learning,” “Deep Learning,” and “Neural Network Technology,” as well as in Le et al, Building High-Level Features Using Large Scale Unsupervised Learning, arXiv preprint arXiv:1112.6209 (2011), and Coates et al, Deep Learning with COTS HPC Systems, Proceedings of the 30th International Conference on Machine Learning (ICML-13), 2013. These journal papers, and then-current versions of the “Machine Learning” and “Neural Network Technology” articles, are attached as appendices to patent application 61/861,931, filed Aug. 2, 2013.

This specification has discussed different embodiments. It should be understood that the methods, elements and concepts detailed in connection with one embodiment can be combined with the methods, elements and concepts detailed in connection with other embodiments. While some such arrangements have been particularly described, many have not—due to the large number of permutations and combinations. Applicant similarly recognizes and intends that the methods, elements and concepts of this specification can be combined, substituted and interchanged—not just among and between themselves, but also with those known from the cited prior art. Moreover, it will be recognized that the detailed technology can be included with other technologies—current and upcoming—to advantageous effect. Implementation of such combinations is straightforward to the artisan from the teachings provided in this disclosure.

While this disclosure has detailed particular ordering of acts and particular combinations of elements, it will be recognized that other contemplated methods may re-order acts (possibly omitting some and adding others), and other contemplated combinations may omit some elements and add others, etc.

Although disclosed as complete systems, sub-combinations of the detailed arrangements are also separately contemplated (e.g., omitting various of the features of a complete system).

While certain aspects of the technology have been described by reference to illustrative methods, it will be recognized that apparatuses configured to perform the acts of such methods are also contemplated as part of applicant's inventive work. Likewise, other aspects have been described by reference to illustrative apparatus, and the methodology performed by such apparatus is likewise within the scope of the present technology. Still further, tangible computer readable media containing instructions for configuring a processor or other programmable system to perform such methods is also expressly contemplated.

The present specification should be read in the context of the cited references. Those references disclose technologies and teachings that the applicant intends be incorporated into embodiments of the present technology, and into which the technologies and teachings detailed herein be incorporated.

To provide a comprehensive disclosure, while complying with the statutory requirement of conciseness, applicant incorporates-by-reference each of the documents referenced herein. (Such materials are incorporated in their entireties, even if cited above in connection with specific of their teachings.) These references disclose technologies and teachings that can be incorporated into the arrangements detailed herein, and into which the technologies and teachings detailed herein can be incorporated. The reader is presumed to be familiar with such prior work.

The claims submitted with this application address just a small fraction of the patentable inventions disclosed herein. Applicant expects many more, and broader, claims will be issued from this patent family.

In view of the wide variety of embodiments to which the principles and features discussed above can be applied, it should be apparent that the detailed embodiments are illustrative only, and should not be taken as limiting the scope of the invention. Rather, applicant claims as the invention all such modifications as may come within the scope and spirit of the following claims and equivalents thereof.

1. An input peripheral device in a wristwatch form factor, the device including:
a central unit and a wristband;
the wristband including a first portion extending from the central unit in a first direction, and a second portion extending from the central unit in an opposite direction, each of said portions of the wristband including an exposed top surface;
the first portion of the wristband including a first sensor array comprising one or more sensors, and the second portion of the wristband including a second sensor array comprising one or more sensors;
wherein the device is adapted to sense and distinguish taps by index, middle, fourth and pinky fingers of a user's hand on the top surface of said first and second portions of the wristband.

2. The device of claim 1 in which:
the first sensor array comprises four sensors adapted to respectively sense taps by index, middle, fourth and pinky fingers of the user's first hand on the top surface of the first portion of the wristband; and
the second sensor array comprises four sensors adapted to respectively sense taps by index, middle, fourth and pinky fingers of the user's second hand on the top surface of the second portion of the wristband.

3. The device of claim 2 in which each of said four sensors comprises a vibration, capacitive, inductive, acoustic or optical sensor.

4. The device of claim 1 in which:
the first and second portions of the wristband each includes first and second edge regions;
the first sensor array includes additional sensors adapted to sense the user's fingers proximate to the first and second edge regions of the first portion of the wristband; and
the second sensor array includes additional sensors adapted to sense the user's fingers proximate to the first and second edge regions of the second portion of the wristband.

5. The device of claim 4 in which the first sensor array includes four sensors disposed in the first edge region of the first portion of the wristband, to respectively sense and distinguish presence of the user's index, middle, fourth, and pinky fingers proximate to said first edge region.

6. The device of claim 5 in which each of said four sensors comprises a vibration, capacitive, inductive, acoustic or optical sensor.

7. The device of claim 1 including a memory containing instructions that program a processor, the instructions being adapted to cause a touch to a touch-sensitive top surface of the central unit to serve as a shift control for keyboard input, changing a meaning of a finger signal sensed by the sensor array.

8. The device of claim 7 in which the central unit includes a display screen, and said instructions are adapted to present information on the display screen indicating a shift control state for keyboard input.

9. The device of claim 1 including a memory containing instructions that program a processor, the instructions being adapted to cause a touch gesture applied to a touch-sensitive top surface of the central unit to serve as a cursor control signal for moving a cursor on an associated display device.

10-11. (canceled)

12. A method comprising the acts:
removing a wearable device from a user's wrist and putting it on a first surface;
sensing taps of the user's fingers both on the device, and away from the device, said sensing being performed by plural hardware sensors—at least some of which are disposed in a wristband of the wearable device; and
sending data corresponding to said taps to a second device.

13. The method of claim 12 in which the first surface comprises the user's thigh.

14. The method of claim 12 in which the act of sensing taps away from the device employs sensors located in edge portions of the wristband.

15. An input peripheral device in a wristwatch form factor, the device including:
a central unit and a wristband;
the wristband including a first and second portions extending from the central unit in opposite directions along a lengthwise axis, the wristband having a median portion and two edges;
the wristband including plural first sensors disposed in the median portion along a length of the wristband; and
the wristband including plural second sensors disposed along a first edge thereof.

16. The device of claim 15, further including plural third sensors disposed along a second edge thereof.

17. The device of claim 16, wherein there is an unequal number of second and third sensors.

18. The device of claim 15, wherein there is an unequal number of first and second sensors.

19-20. (canceled)
